(19) United States
(12) Patent Application Publication
(10) Pub. No.: US 2012/0088559 A1
(43) Pub. Date: Apr. 12, 2012

(54) MOBILE DEVICE HOUSING WITH INTERCHANGEABLE BACKING

(75) Inventors: Christopher Michael MCSWEYN, Oxnard, CA (US); Jesse VANDIVER, Oxnard, CA (US)

(73) Assignee: SCOSCHE INDUSTRIES, INC., Oxnard, CA (US)

(21) Appl. No.: 13/252,957

(22) Filed: Oct. 4, 2011

Related U.S. Application Data
(60) Provisional application No. 61/391,421, filed on Oct. 8, 2010.

(51) Int. Cl. H04W 88/02; B23P 11/00

(52) U.S. Cl. 455/575.1; 29/428

(57) ABSTRACT

A housing for mobile devices is disclosed herein. The housing includes a shell having an interior portion displaced therein configured to fit a mobile device; a first opening through which the interior portion is accessible for inserting the mobile device; a second opening configured to be smaller than the mobile device; and a housing support displaced around the second opening. The housing also includes an insert configured to fit in and cover the second opening, the insert having a first surface facing the interior portion of the shell once the insert has been placed in the shell; and a second surface opposite to the first surface and facing the outside of the housing once the insert has been placed in the cell. A method for making the same is also disclosed.

### CROSS-REFERENCE TO RELATED APPLICATION

This Application claims priority from U.S. Provisional Application Ser. No. 61/391,421, filed Oct. 8, 2010, the contents of which are hereby incorporated by reference herein in their entirety.

### BACKGROUND

1. Field

The present disclosure relates to electronic device covers, and, more particularly, to a mobile device housing with interchangeable backing.

2. Description of Related Art

Housings, also known as cases, are used for any variety and number of purposes to protect electronic devices such as cameras, camcorders and other products from exposure to weather and other elements. Housings are also used to hold products such as flashlights, cell phones, global positioning systems (GPS), personal digital assistants (PDA's) portable radios and other similar handheld devices (herein collectively “electronic device”). Certain housings also have the additional feature of providing a belt strap or other interconnection mechanism to attach the housing to a user's belt or clothing. This feature prevents the housing and associated electronic device from being inadvertently lost or stolen, yet allowing a user to have their hands free for other uses. Although the clip can be used on a belt, the carrying apparatus and enclosed electronic device cannot be supported in a stable upright position on a flat object such as a desk top. Other types of housing include a backing with a stand that allows the enclosed electronic device to be held in an upright position. Still other housings provide a flat surface on the back to keep the housing low in profile. Although having a variety of different backings provide options to the user to choose a case that includes features useful to the user, the manufacturing of different cases increases cost and inefficiencies for the supplier and distributors of the cases

It would be desirable to address one or more of the issues discussed above.

### SUMMARY

To address the various issues described herein, It is one aspect of the present invention to provide a housing having a shell including an interior portion displaced therein configured to fit a mobile device; a first opening through which the interior portion is accessible for inserting the mobile device; a second opening configured to be smaller than the mobile device; and a housing support displaced around the second opening. The housing further includes an insert configured to fit in and cover the second opening, the insert having a first surface facing the interior portion of the shell once the insert has been placed in the shell; and a second surface opposite to the first surface and facing the outside of the housing once the insert has been placed in the cell.

In another aspect of the present invention, a method for making a housing includes providing a shell having an interior portion displaced therein configured to fit a mobile device; a first opening through which the interior portion is accessible for inserting the mobile device; a second opening configured to be smaller than the mobile device; and a housing support displaced around the second opening. The method further includes providing an insert configured to fit in and cover the second opening, the insert having a first surface facing the interior portion of the shell once the insert has been placed in the shell; and a second surface opposite to the first surface and facing the outside of the housing once the insert has been placed in the cell.

It is understood that other aspects of a mobile device housing will become readily apparent to those skilled in the art from the following detailed description, wherein it is shown and described only exemplary configurations of a mobile device housing. As will be realized, the disclosure includes other and different aspects of a mobile device housing and the various details presented throughout this disclosure are capable of modification in various other respects, all without departing from the spirit and scope of the novel and unobvious aspects of the invention. Accordingly, the drawings and the detailed description are to be regarded as illustrative in nature and not as restrictive.

### BRIEF DESCRIPTION OF THE DRAWINGS

FIG. 1 is a perspective exploded view of a mobile device housing with interchangeable backing configured in accordance with one aspect of the invention, with an interchangeable backing being shown to be placed into a housing;

FIG. 2 is a perspective view of the mobile device housing configured in accordance with one aspect of the invention, where the interchangeable backing having been inserted into the housing;

FIG. 3 is a cross-sectional view of the mobile device housing of FIG. 2 taken along lines 3-3 of FIG. 2;

FIG. 4A is a perspective view of the interchangeable backing of FIG. 1;

FIG. 4B is a perspective view of a second interchangeable backing configured in accordance with one aspect of the invention that includes a fold-out support;

FIG. 4C is a perspective view of a third interchangeable backing of FIG. 1 configured in accordance with one aspect of the invention that includes an attachment for a clip;

FIG. 5 is a perspective view of the mobile device housing with the second interchangeable backing of FIG. 4B having been inserted into the mobile device housing;

FIG. 6 is a perspective view of the mobile device housing with the second interchangeable backing of FIG. 4B having been inserted into the mobile device housing and deployed;

FIG. 7 is a perspective view of the mobile device housing with the third interchangeable backing of FIG. 4C having been inserted into the mobile device housing and a belt attachment configured in accordance with one aspect of the invention;

FIG. 8 is an exploded perspective view of a second mobile device housing with interchangeable backing configured in accordance with one aspect of the invention, with a first interchangeable backing being shown to be placed into a housing;

FIG. 9 is a second exploded perspective view of the second mobile device housing of FIG. 8, with the first interchangeable backing being shown to be placed into the housing;

FIG. 10 is a perspective view of the second mobile device housing of FIG. 8, where the first interchangeable backing having been inserted into the housing;

FIG. 11 is a second perspective view of the second mobile device housing of FIG. 8, where the first interchangeable backing having been inserted into the housing;

FIG. 12 is a front plan view of the second mobile device housing of FIG. 8;

FIG. 13 is a rear plan view of the second mobile device housing of FIG. 8, where the first interchangeable backing having been inserted into the housing;

FIG. 14 is an exploded perspective view of the second mobile device housing of FIG. 8, with a mobile device being shown to be placed into a housing;

FIG. 15 is a second exploded perspective view of the second mobile device housing of FIG. 8, with the mobile device being shown to be placed into the housing;

FIG. 16 is a perspective view of the second mobile device housing of FIG. 8, with the mobile device having been placed into the housing;

FIG. 17 is a perspective view of the second mobile device housing with interchangeable backing configured in accordance with one aspect of the invention, with a second interchangeable backing; and

FIG. 18 is a perspective view of the second mobile device housing with interchangeable backing configured in accordance with one aspect of the invention, with a third interchangeable backing having been inserted into the housing.

### DETAILED DESCRIPTION

The disclosed housing is described more fully hereinafter with reference to the accompanying drawings, in which various aspects of a mobile device housing with interchangeable backing are shown. The disclosed housing, however, may be embodied in many different forms and should not be construed as limited by the various aspects of the mobile device housing presented herein. The detailed description of the mobile device housing is provided below so that this disclosure will be thorough and complete, and will fully convey the scope of the present disclosure to those skilled in the art.

The detailed description may include specific details for illustrating various aspects of a mobile device housing with interchangeable backing. However, it will be apparent to those skilled in the art that the various aspects of the disclosure may be practiced without these specific details. In some instances, well known elements may be shown in block diagram form, or omitted, to avoid obscuring the novel and unobvious concepts presented throughout this disclosure. Further, although the various embodiments may be described in terms of use with a mobile device such as a cellular phone, the described mobile device housing may be used for a variety of devices, including cameras, flashlights, global positioning systems (GPS), personal digital assistants (PDA's), multimedia players, portable radios and other similar handheld devices.

Various aspects of an mobile device housing may be illustrated by describing components that are coupled together. As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of a mobile device housing with interchangeable backing in addition to the orientation depicted in the drawings. By way of example, if a mobile device housing with interchangeable backing in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a mobile device housing with interchangeable backing may be illustrated with reference to one or more exemplary embodiments. As used herein, the term “exemplary” means “serving as an example, instance, or illustration,” and should not necessarily be construed as preferred or advantageous over other aspects of a mobile device housing with interchangeable backing disclosed herein.

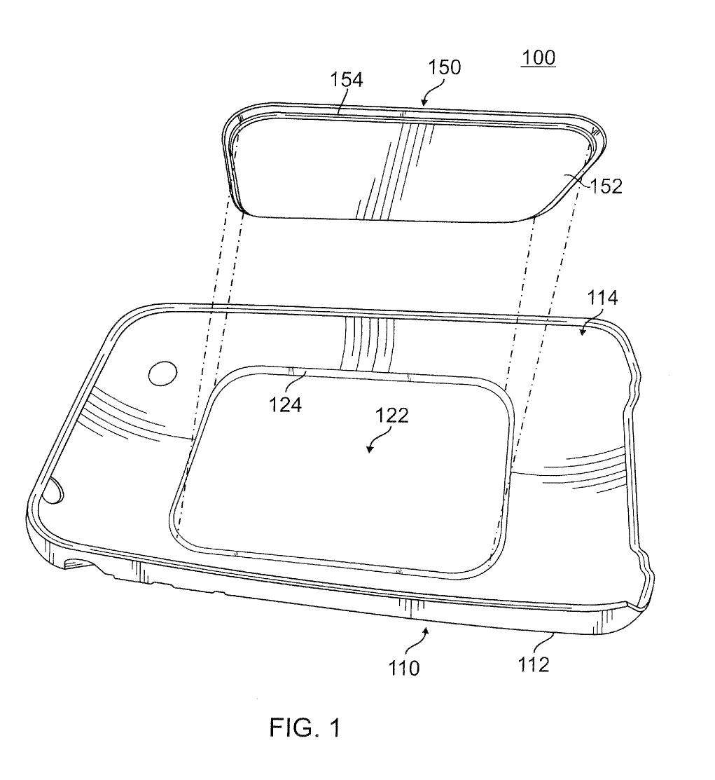

FIG. 1 is a perspective exploded view of a mobile device housing 100 configured in accordance with one aspect of the invention, with an interchangeable backing 150 being shown to be placed into a housing 110 that is also referred to as a shell. Specifically, the housing 110 includes an interior chamber portion 114 into which a mobile device (not shown) will be placed, and an opening 122 displaced in the interior chamber portion 114. A backing support 124 surrounds the opening 122. A lip 154 of the interchangeable backing 150 will rest on top of the backing support 124 of housing 110. Once inserted, an exterior backing surface 152 will be on the same surface as an exterior device housing surface 112.

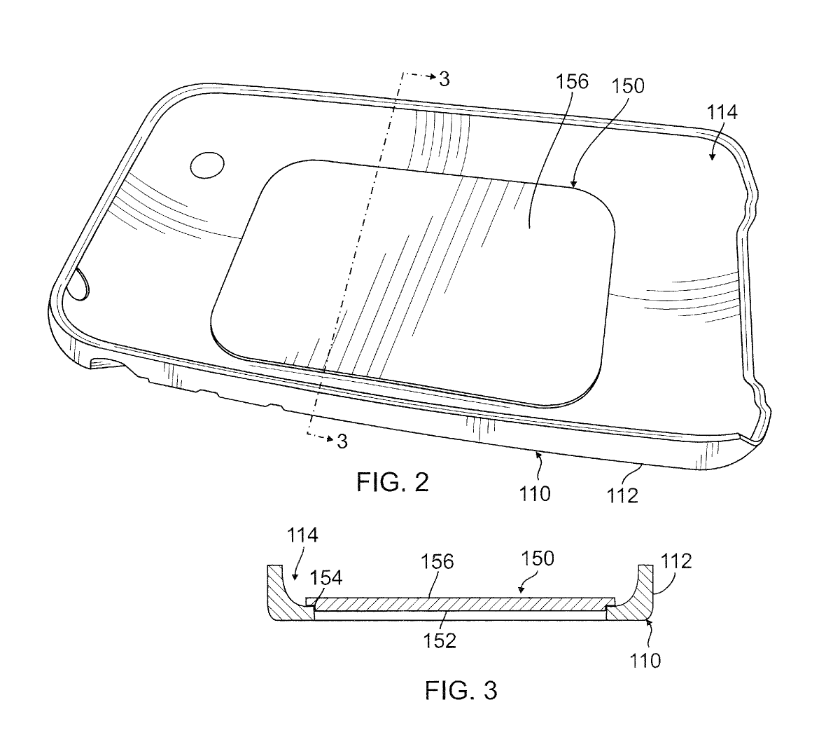

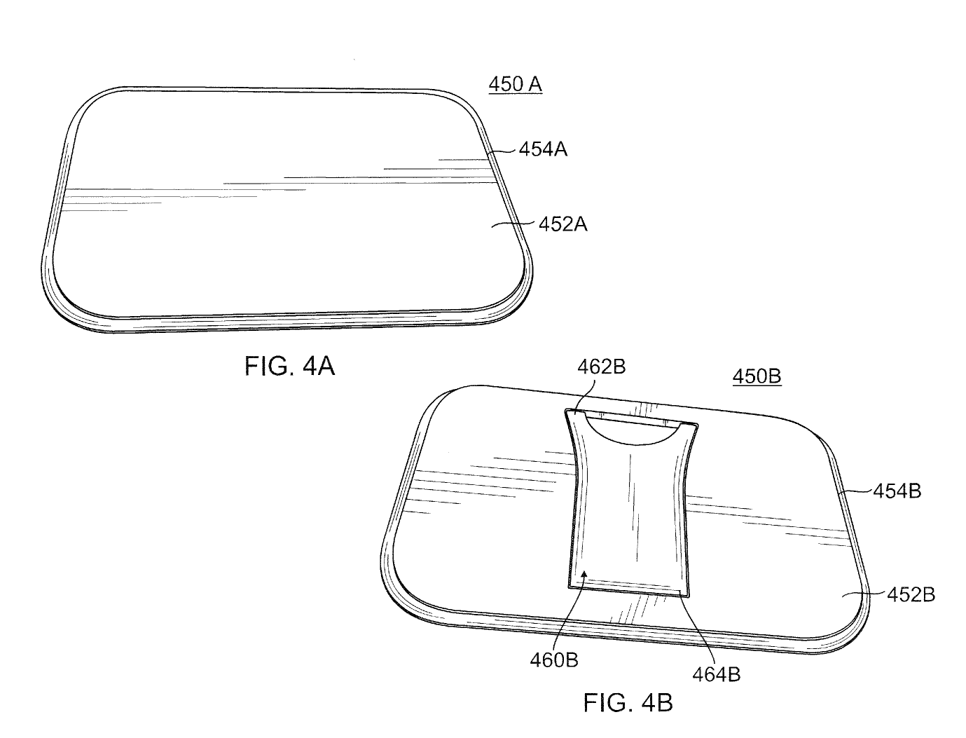

Referring now to FIGS. 2 and 3, which illustrate the interchangeable backing 150 having been inserted into the interior chamber portion 114 of the housing 110, a back surface of 156 of the interchangeable backing 150 will contact a back surface of the mobile device. In one aspect of the invention, the mobile device will hold the interchangeable backing 150 in place once the mobile device is inserted. As detailed by the cross section illustrated in FIG. 3 taken along line 3-3 in FIG. 2, the lip 154 of the interchangeable backing 150 rests on the backing support 124 of housing 110.

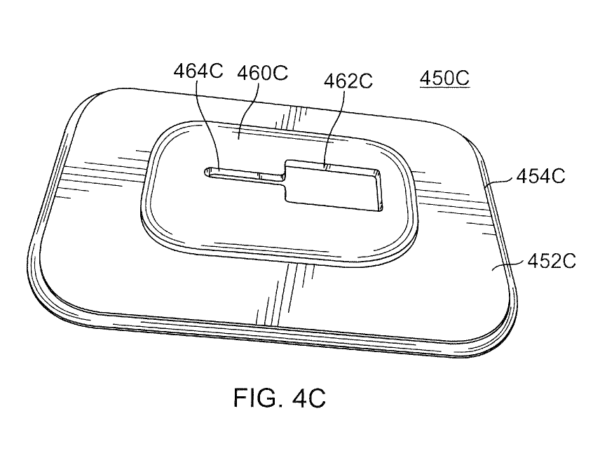

FIGS. 4A-4C illustrate the various embodiments of an interchangeable backing, including a flat interchangeable backing 450A; a standable interchangeable backing 450B; and a clip-on interchangeable backing 450C, respectively. Each interchangeable backing includes a back surface 452A-452C, with the back surface 452A being a flat surface; the back surface 452B having a stand 460B; and the back surface 452C having a clip-on 460C. The stand 460B includes a hinge 464B that allows a leg support 462B to fold out. The clip-on 460C includes an opening 462C into which a clip tab (shown and described further herein) on a user's belt may be inserted.

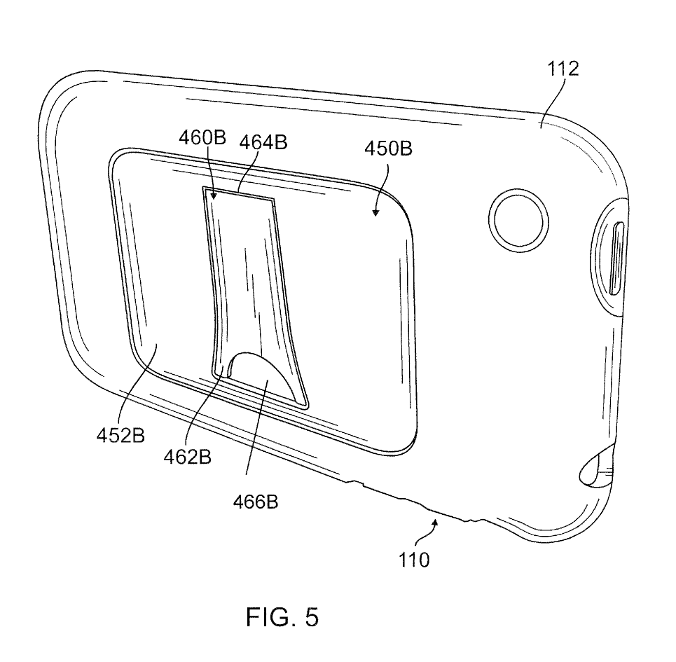

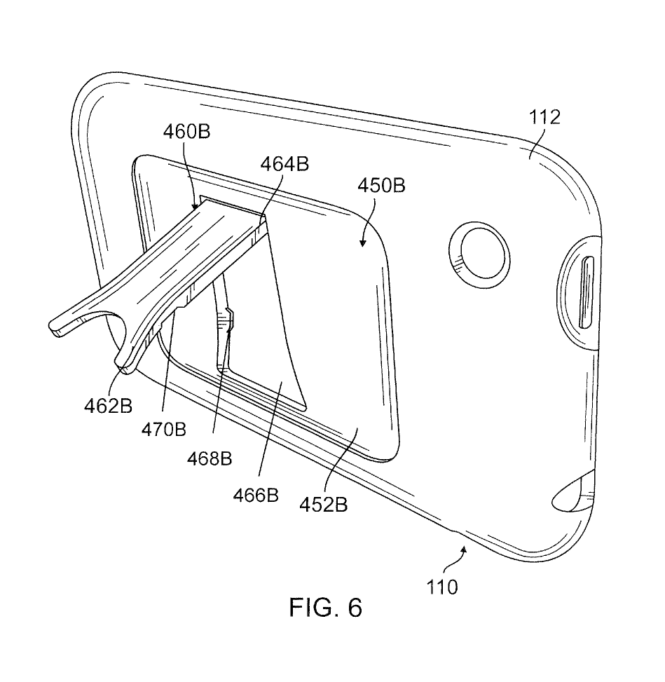

FIG. 5 illustrates the standable interchangeable backing 450B having been inserted in the housing 110 and held in place by a mobile device. As shown, the leg support 462B remains folded using the hinge 464B. In one embodiment of the invention, the leg support 462B is recessed into the back surface 452B of the standable interchangeable backing 450B when the leg support 462B is not deployed. Referring also to FIG. 6, the leg support 462B is shown deployed in an unfolded position to support the mobile device for display.

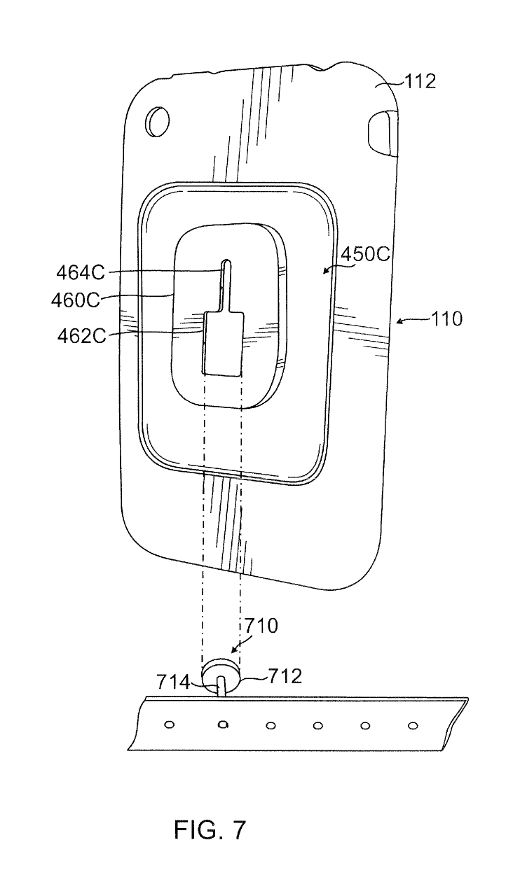

FIG. 7 illustrates the clip-on interchangeable backing 450C having been inserted into the housing 110 and held in place by a mobile device. The clip-on interchangeable backing 450C is use to clip onto a belt that includes a clip tab 710. The clip tab 710 includes a button 712 mounted on a stem 714. The button 712 is sized to fit into the opening 462C and the stem 714 slides into and is retained by a slot 464C, thereby allowing the clip tab 710 to be held in place in the clip-on 460C. Once clipped on, the mobile device will hang on the belt.

Although three specific embodiments for a mobile device housing interchangeable backing are shown herein, it may be seen that other interchangeable backings can be used. By way of example and not limitation, other backings such as other types of clips of fixture mechanism may be used.

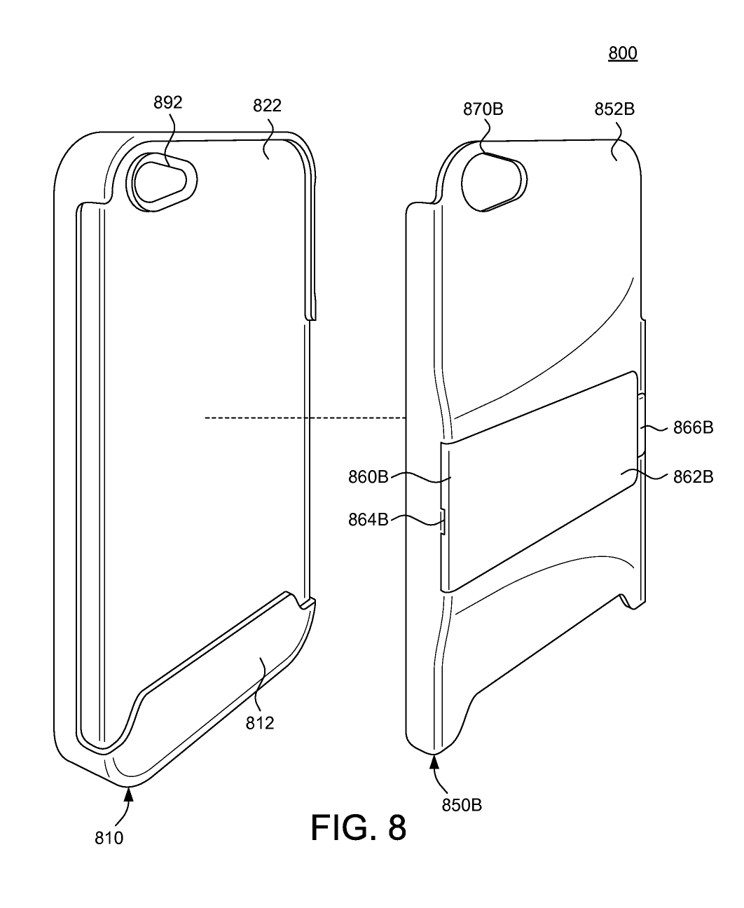

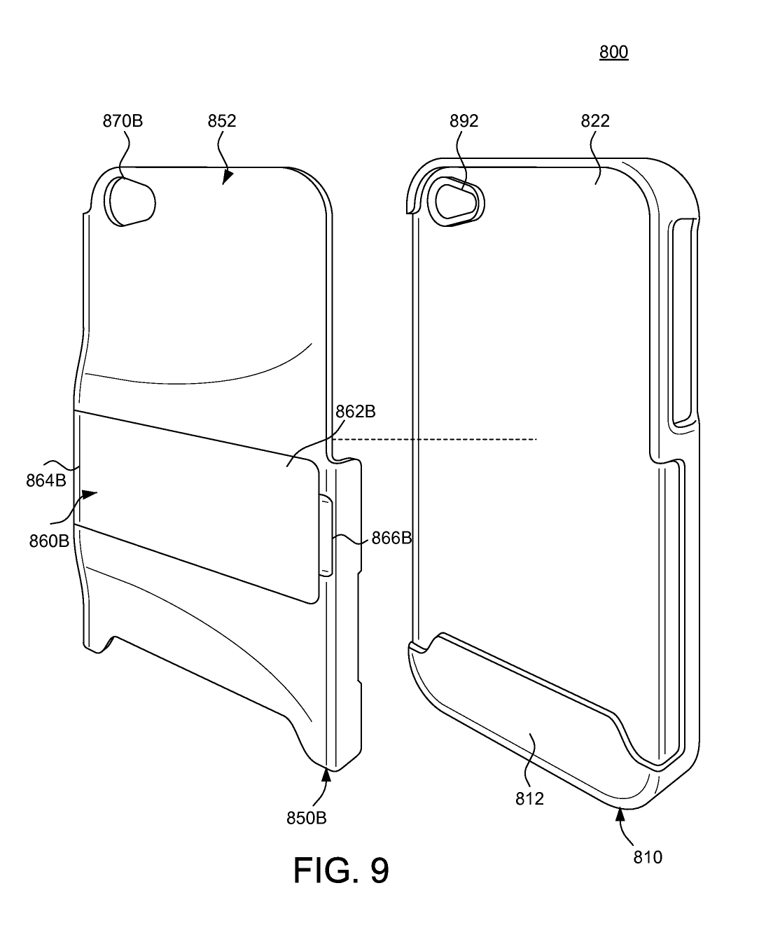

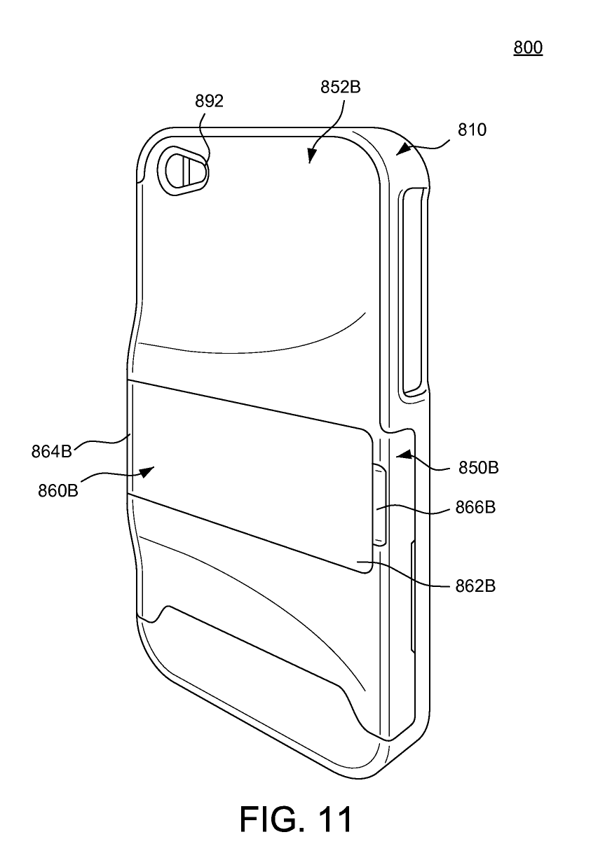

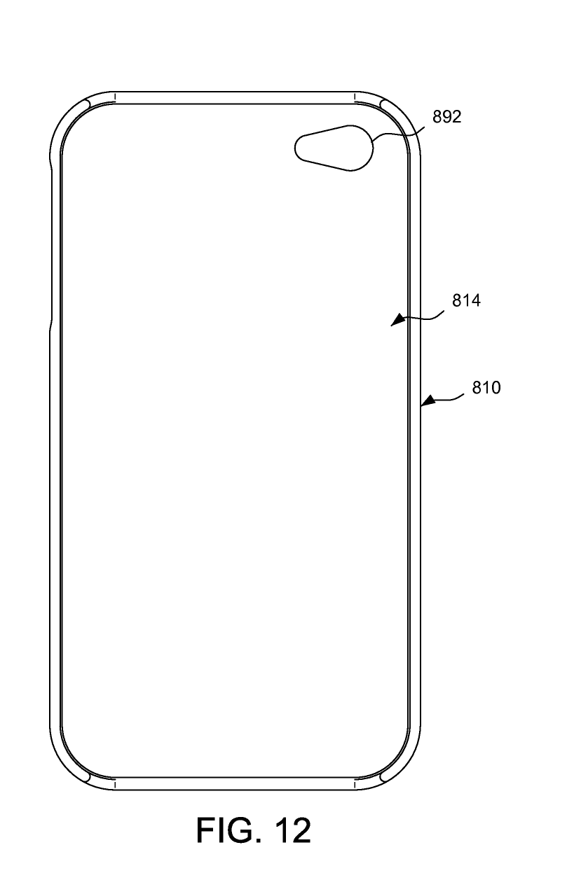

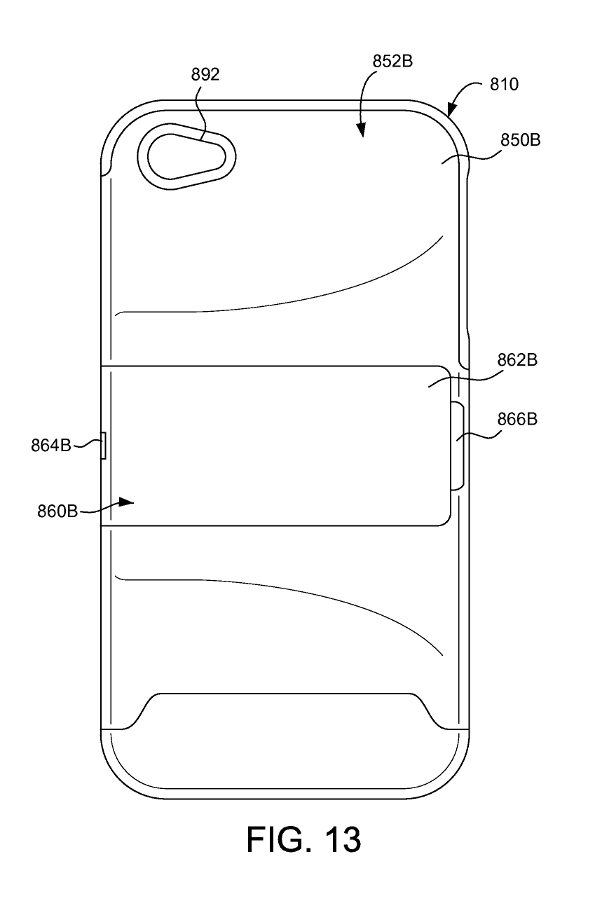

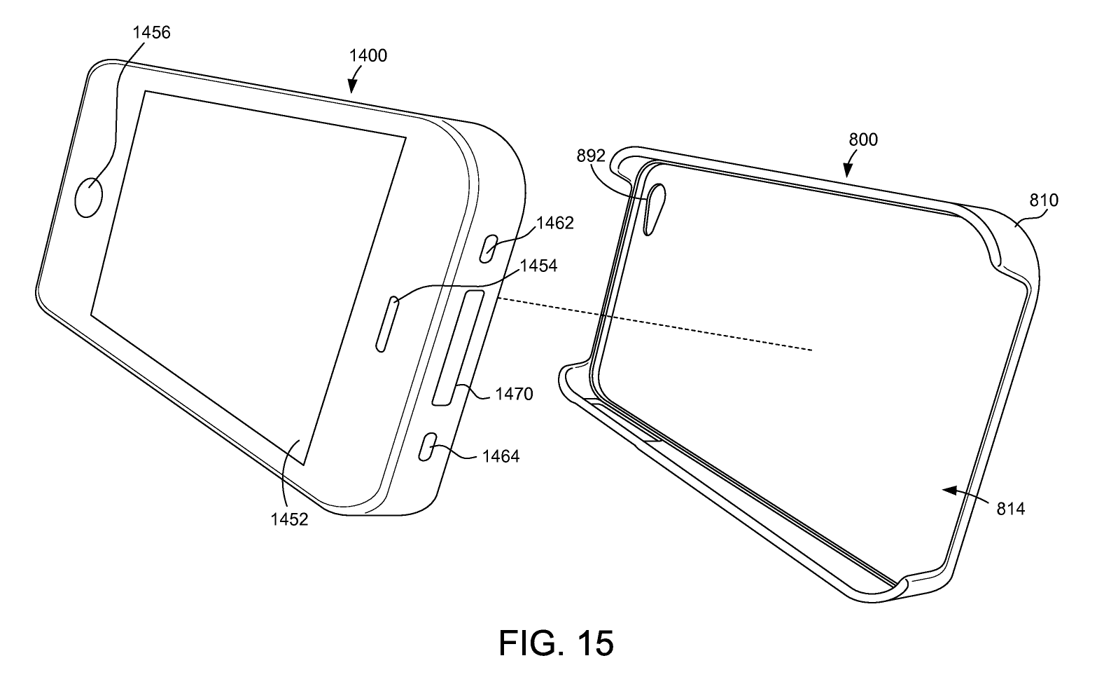

FIG. 8-18 illustrates a second mobile device housing 800 configured in accordance with one embodiment of the present invention. FIGS. 8 and 9 are two perspective exploded views of the second mobile device housing 800 configured in accordance with one aspect of the invention, with a kickstand interchangeable backing 850B being shown to be placed into a second housing 810, also referred to as a shell. Specifically, referring also to FIGS. 12 and 15, the second housing 810 includes an interior chamber portion 814 into which a mobile device 1400 will be placed. The second housing 810 includes a back housing surface 822 onto which the kickstand interchangeable backing 850B may be placed and supported. Once inserted, an exterior backing surface 852B will be on the same surface as an exterior device housing surface 812. In this embodiment, the kickstand interchangeable backing 850B may be replaced with another interchangeable backing, as further described below, without the mobile device 1400 having to be removed from the second housing 810.

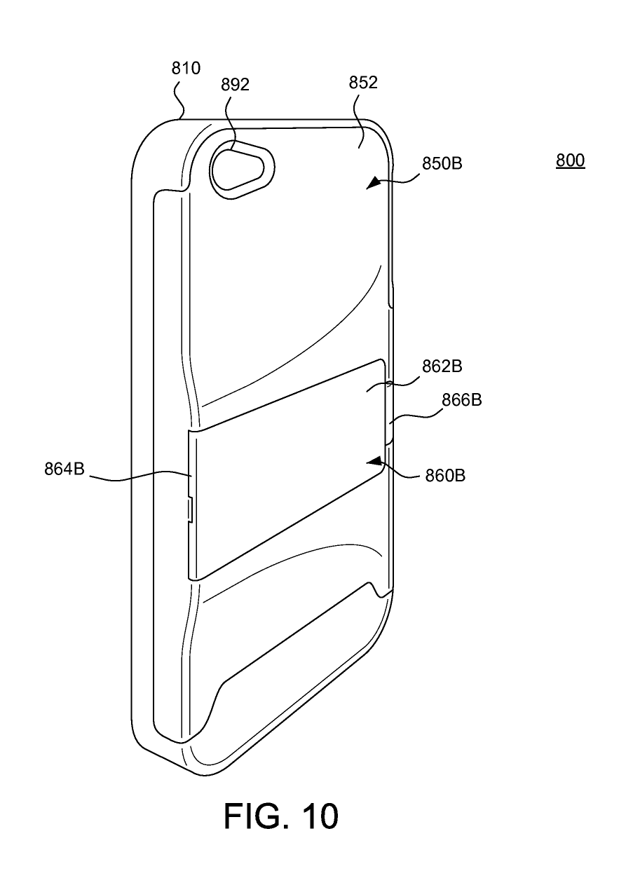

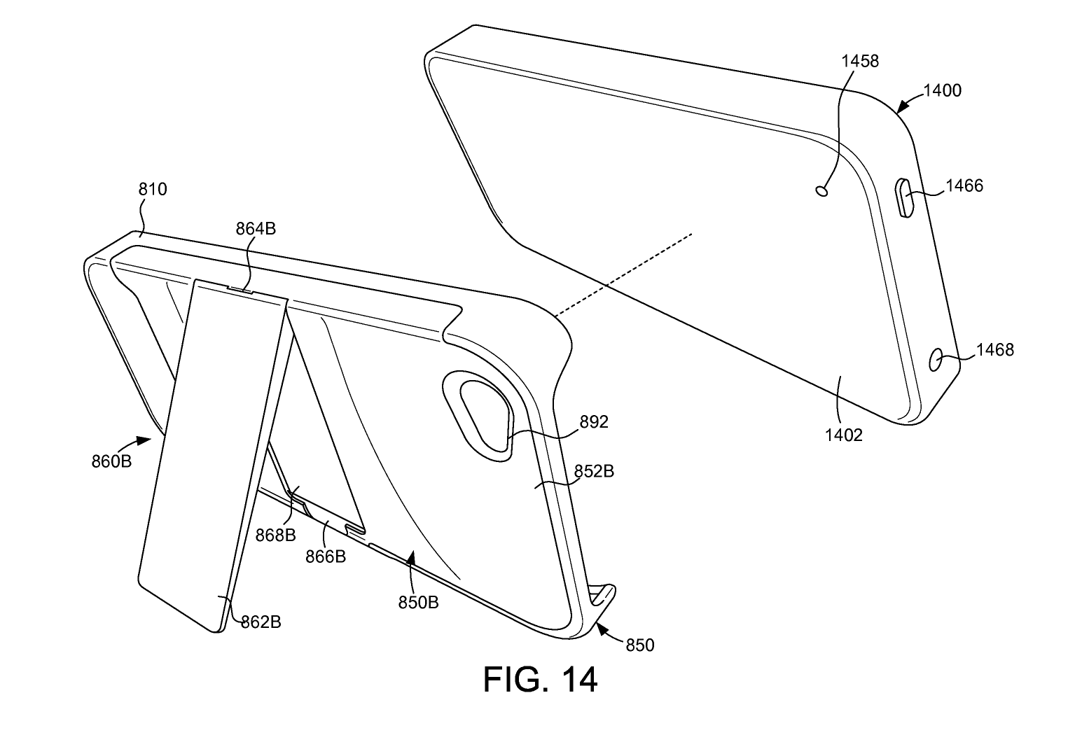

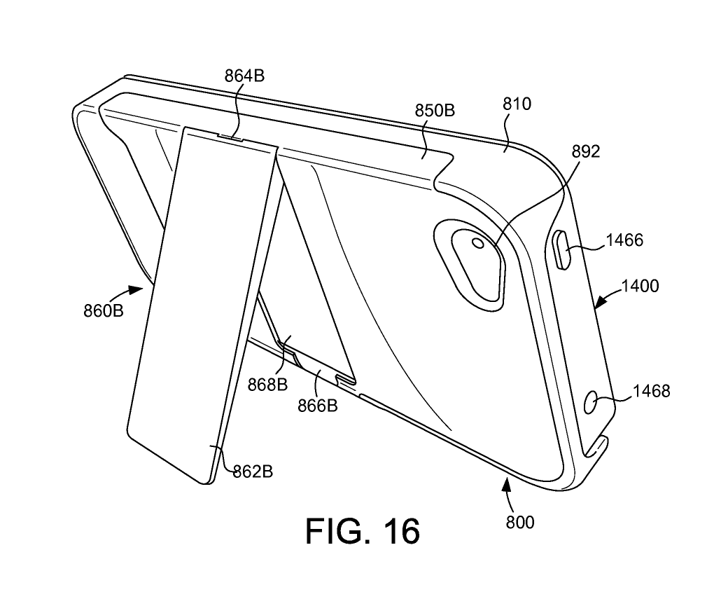

Continuing to refer to FIGS. 8 and 9, and referring also to FIGS. 10, 11 and 13, which illustrate the kickstand interchangeable backing 850B having been inserted onto the back housing surface 822 of the second housing 810, a stand, or kickstand 860B includes a support 862B that pivots around a hinge 864B. In one embodiment, the kickstand 860B includes a notched portion 866B recessed in the kickstand interchangeable backing 850B so that the support 862B may be deployed. Further, referring to FIGS. 14 and 16, a recessed portion 868B is included in the back surface 852B of the kickstand interchangeable backing 850B so that the support 862B may be tucked therein and remain more flush when the leg support 862B is not deployed. In FIG. 14, the support 862B is shown in an unfolded, deployed position to support the mobile device 1400 for display.

Referring to FIGS. 14-16, the mobile device 1400 is being placed into the second mobile device housing 800 with the kickstand interchangeable backing 850B, where a back surface 1402 of the mobile device 1400 is inserted into the interior chamber portion 814. The mobile device 1400 is retained by the second mobile device housing 800 through friction forces. In other embodiments, the mobile device 1400 may be retained in the second mobile device housing 800 by other means that are known by those skilled in the art, including but not limited to clips, hook-and-loop-type fasteners, ridges, etc. In the example shown, the mobile device 1400 includes a plurality of buttons and receptacles 1462, 1464, 1466, 1468 and 1470, which is preferable still accessible after the mobile device 1400 has been placed in the mobile device housing 800. Further, the mobile device 1400 also includes a plurality of multimedia devices 1452, 1454, 1456, and 1458, which may include cameras, screens, and speakers, and is preferably accessible after the mobile device 1400 has been placed in the mobile device housing 800. For example, the mobile device housing 800 and the kickstand interchangeable backing 850B may include openings 892 and 870B, respectively, for accessibility of the multimedia device 1458. Thus, in one aspect of the invention, the mobile device housing 800 is customized to be used with the mobile device 1400.

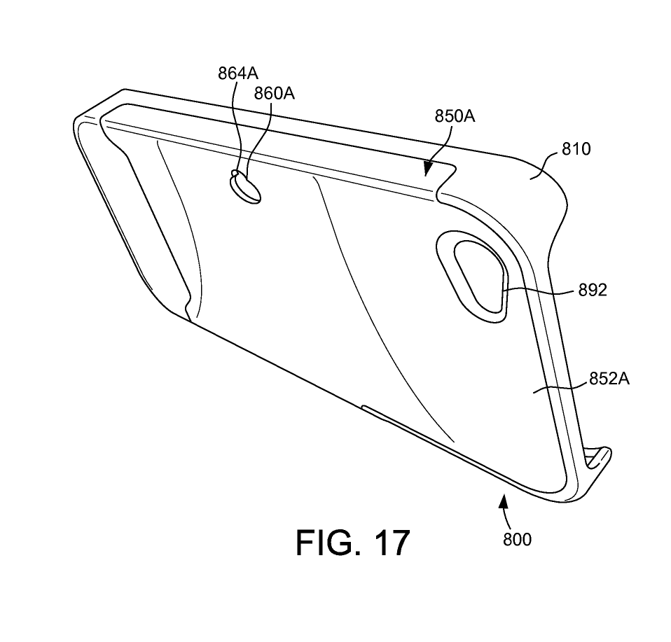

FIG. 17 illustrates another embodiment of a backing that may be used with the second device housing 800 in lieu of the kickstand interchangeable backing 850B. Specifically, a hook interchangeable backing 850C having been inserted onto the second mobile device housing 800. The hook interchangeable backing 850C includes a hook 860C that is used to hook onto a belt, pant or skirt waist, straps or other flat edge that can support the hook interchangeable backing 850C.

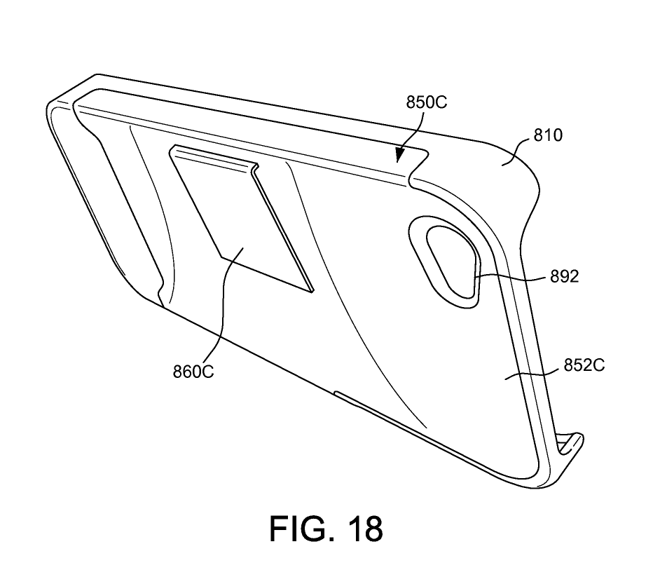

FIG. 18 illustrates another embodiment of a backing that may be used with the second device housing 800. Specifically, a clip-on interchangeable backing 850C having been inserted onto the second mobile device housing 800. The clip-on interchangeable backing 850A is use to clip onto the clip tab 710 illustrated in FIG. 7. The clip tab 710 includes the button 712 mounted on the stem 714. The button 712 is sized to fit into the an opening 860A and the stem 714 slides into and is retained by a slot 864A, thereby allowing the clip tab 710 to be held in place with the interchangeable backing 850A. Once clipped on, the mobile device 1400 will hang on the belt.

Although several backings have been described, it should be apparent that other embodiments of backings may be used with the mobile device housing 100 and the second device housing 800.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A housing, comprising:
a shell comprising:
an interior portion displaced therein configured to fit a mobile device;
a first opening through which the interior portion is accessible for inserting the mobile device;
a second opening configured to be smaller than the mobile device; and
a housing support displaced around the second opening; and
an insert configured to fit in and cover the second opening, the insert comprising:
a first surface facing the interior portion of the shell once the insert has been placed in the shell; and
a second surface opposite to the first surface and facing the outside of the housing once the insert has been placed in the cell.

2. The housing of claim 1, wherein the insert further comprising an insert support configured to mate to the housing support.

3. The housing of claim 1, wherein the housing support is displaced on the interior portion of the housing and is configured to contact the second surface of the insert.

4. The housing of claim 1, wherein the second surface of the insert comprises a stand.

5. The housing of claim 1, wherein the second surface of the insert comprises a clip.

6. The housing of claim 1, wherein the housing support comprises a lip configured to mate to the second surface of the insert.

7. A method for making a housing comprising:
providing a shell comprising:
an interior portion displaced therein configured to fit a mobile device;
a first opening through which the interior portion is accessible for inserting the mobile device;
a second opening configured to be smaller than the mobile device; and
a housing support displaced around the second opening; and
providing an insert configured to fit in and cover the second opening, the insert comprising:
a first surface facing the interior portion of the shell once the insert has been placed in the shell; and
a second surface opposite to the first surface and facing outside of the housing once the insert has been placed in the cell.

8. The method of claim 7, wherein the insert further comprising an insert support configured to mate to the housing support.

9. The method of claim 7, wherein the housing support is displaced on the interior portion of the housing and is configured to contact the second surface of the insert.

10. The method of claim 7, wherein the second surface of the insert comprises a stand.

11. The method of claim 7, wherein the second surface of the insert comprises a clip.

12. The method of claim 7, wherein the housing support comprises a lip configured to mate to the second surface of the insert.

13. A housing, comprising:
a shell comprising:
an interior portion displaced therein configured to fit a mobile device;
a first opening through which the interior portion is accessible for inserting the mobile device;
a backing support; and
an interchangeable backing configured to fit on the backing support, the interchangeable backing comprising:
a first surface facing the backing support once the interchangeable backing has been placed on the backing support; and
a second surface opposite to the first surface and facing outside of the housing once the interchangeable backing has been placed on the backing support.

14. The housing of claim 13, wherein the interchangeable backing support comprises a surface configured with a first shape, and the first surface of the interchangeable backing further comprising an insert support configured to mate to the housing support.

15. The housing of claim 13, wherein the interchangeable backing support is displaced on the interior portion of the housing and is configured to contact the second surface of the insert.

16. The housing of claim 13, wherein the second surface of the insert comprises a stand.

17. The housing of claim 16, wherein the stand comprises:
a hinge; and
a support coupled to the hinge and configured to be swung to a deployed position.

18. The housing of claim 17, wherein the second surface of the insert comprises a recess, and the support is configured to fit into the recess for storage.

19. The housing of claim 13, wherein the second surface of the insert comprises a clip.
